(19) United States
(12) Patent Application Publication
(10) Pub. No.: US 2007/0124582 A1
(43) Pub. Date: May 31, 2007

(54) System and Method for an NSP or ISP to Detect Malware in its Network Traffic

(76) Inventors: Marvin Shannon, (US); Wesley Boudville, (US)

Correspondence Address: MARVIN SHANNON, 3579 EAST FOOTHILL BLVD, #328, PASADENA, CA, 91107, US

(21) Appl. No.: 11/462,711

(22) Filed: Aug. 6, 2006

Related U.S. Application Data
(60) Provisional application No. 60/595,805, filed on Aug. 7, 2005.
(60) Provisional application No. 60/595,806, filed on Aug. 7, 2005.

(51) Int. Cl. H04L 9/00

(52) U.S. Cl. 713/164

(57) ABSTRACT

We show how a Network Service Provider (NSP) can detect if any of its customers are involved in malware. Like spamming or phishing. This involves the NSP's router performing a sampled packet analysis of outgoing and incoming messages. And combining this with our earlier methods for detecting spammer domain clusters (swarms) or phishing. Our method lets an NSP quickly shut down spammer customers, and reduces the risk that it and its innocent customers get blacklisted by other NSPs and ISPs. We use static and dynamic blacklists in the detection of spam/bulk messages in a message stream. Also, we use 3 sets of Bulk Message Envelopes (BMEs). A static set, which might be found from an Aggregation Center. A dynamic blacklisted BME set, which comes from messages hit by our blacklists. And a dynamic BME set that “good” bulk messages are put into. In tests, our method has programatically and consistently detected around 80% of sets of email messages as bulk/spam.

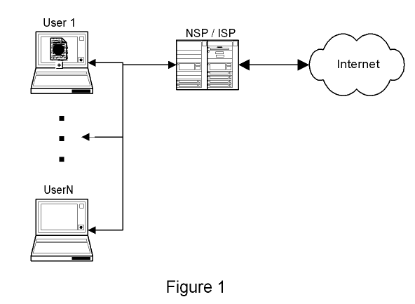

### CROSS-REFERENCES TO RELATED APPLICATIONS

This application claims the benefit of the filing date of U.S. Provisional Application, No. 60/595805, “System and Method for an NSP to Detect Malware in its Network Traffic”, filed Aug. 7, 2005, which is incorporated by reference in its entirety. It also incorporates by reference in its entirety the U.S. Provisional Application, No. 60/595806, “System and Method of Using Blacklists and Bulk Message Envelopes Against Spam and Phishing”, filed Aug. 7, 2005.

### REFERENCES CITED

spam.abuse.net

ftc.gov/spam

en.wikipedia.org/wiki/Spam_(electronic)

Postini Corp. spam survey, postini.com/whitepapers/ThreatReport.pdf

Antiphishing Working Group, antiphishing.org

en.wikipedia.org/wiki/Phishing

### TECHNICAL FIELD

This invention relates generally to information delivery and management in a computer network. More particularly, the invention relates to techniques for automatically classifying electronic communications as spam or non-spam and as phishing or non-phishing.

### BACKGROUND OF THE INVENTION

Consider a Network Service Provider (NSP), which provides its customers with their connections to the Internet. These customers often have their own domains and run their own web and mail servers, as well as servers for other types of services, like ftp, for example. For brevity, we define in this invention that an Internet Service Provider which has this relationship with some of its customers to also be an NSP.

As spam (including phishing) and malware, like viruses, have proliferated on the Internet, many methods have been tried to attack them. An NSP might require that its customers agree not to knowingly be involved in the propagation of these objects. Often, this is defensive. Suppose some of its customers were to be involved in sending out massive numbers of spam messages to the Internet. Other ISPs might might place not just that customer on their blacklists, but also the NSP and the rest of its customers. This could mean that email from those customers to addresses at the outside ISPs would not be accepted. Possibly, other types of servers at the outside ISPs might also reject requests from the NSP's customers.

In some cases, this might be warranted, if the NSP is tacitly condoning its customer's spamming, and if there are several such spammer customers. But typically, the NSP and its other customers are innocent victims (collateral damage) of those other ISPs' policies.

Another scenario is that the NSP might have a customer whose computer got taken over by a virus, and turned into a “bot” (short for “robot”) in a “bot net”. This is a network of hijacked computers, that can be used for activities like sending out spam, or being hosting computers for links in spam messages. These actions could have with the customer unaware of any irregularities, until she gets blacklisted at many places. Worse might be if her computer is a server for phishing, where there is one link on phishing messages, that points back to her computer. So that an unsuspecting user would go to her machine and enter personal information. Which the bot would later transmit to the phisher.

Thus, it benefits an NSP and its customers if it was able to scrutinize its outgoing and incoming traffic, to try to detect such malware.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

We show how a Network Service Provider (NSP) can detect if any of its customers are involved in malware. Like spamming or phishing. This involves the NSP's router performing a sampled packet analysis of outgoing and incoming messages. And combining this with our earlier methods for detecting spammer domain clusters (swarms) or phishing. Our method lets an NSP quickly shut down spammer customers, and reduces the risk that it and its innocent customers get blacklisted by other NSPs and ISPs.

We use static and dynamic blacklists in the detection of spam/bulk messages in a message stream. Also, we use 3 sets of Bulk Message Envelopes (BMEs). A static set, which might be found from an Aggregation Center. A dynamic blacklisted BME set, which comes from messages hit by our blacklists. And a dynamic BME set that “good” bulk messages are put into. In tests, our method has programatically and consistently detected around 80% of sets of email messages as bulk/spam.

### BRIEF DESCRIPTION OF THE DRAWINGS

There is one figure. Showing an NSP or ISP connected to the Internet, and also connected to its customers.

### DETAILED DESCRIPTION OF THE PREFERRED EMBODIMENT

What we claim as new and desire to secure by letters patent is set forth in the following claims.

Below, we will also refer to the following U.S. Provisionals submitted by us:

Ser. No. 10/708,757 (“8757”) (ref: Provisional #60/320,046, “System and Method for the Classification of Electronic Communications”, filed Mar. 24, 2003; No. 60/481,745 (“1745”), “System and Method for the Algorithmic Categorization and Grouping of Electronic Communications”, filed Dec. 5, 2003; Ser. No. 10/905037 (“5037”) (ref: Provisional #60/481,789, Provisional #60/481,745),“System and Method for the Algorithmic Disposition of Electronic Communications”, filed Dec. 14, 2003; No. 60/481,899 (“1899”), “Systems and Method for Advanced Statistical Categorization of Electronic Communications”, filed Jan. 15, 2004; No. 60/521,014 (“1014”), “Systems and Method for the Correlation of Electronic Communications”, filed Feb. 5, 2004; No. 60/521,174 (“1174”), “System and Method for Finding and Using Styles in Electronic Communications”, filed Mar. 3, 2004; No. 60/521,622 (“1622”), “System and Method for Using a Domain Cloaking to Correlate the Various Domains Related to Electronic Messages”, filed Jun. 7, 2004; No. 60/521,698 (“1698”), “System and Method Relating to Dynamically Constructed Addresses in Electronic Messages”, filed Jun. 20, 2004; No. 60/521,942 (“1942”), “System and Method to Categorize Electronic Messages by Graphical Analysis”, filed Jul. 23, 2004; No. 60/522,244 (“2244”), “System and Method to Rank Electronic Messages”, filed Sep. 7, 2004; No. 60/522,113 (“2113”), “System and Method to Detect Spammer Probe Accounts”, filed Aug. 17, 2004.

We will refer to the above collectively as the “Antispam Provisionals”.

We will also refer to another set of U.S. Provisionals submitted by us:

No. 60/522,245 (“2245”), “System and Method to Detect Phishing and Verify Electronic Advertising”, filed Sep. 7, 2004; No. 60/522,458 (“2458”), “System and Method for Enhanced Detection of Phishing”, filed Oct. 4, 2004; No. 60/552,528 (“2528”), “System and Method for Finding Message Bodies in Web-Displayed Messaging”, filed Oct. 11, 2004;

No. 60/552,640 (“2640”), “System and Method for For Investigating Phishing Web Sites”, filed Oct. 22, 2004; No. 60/552,644 (“2644”), “System and Method for Detecting Phishing Messages In Sparse Data Communications”, filed Oct. 24, 2004; No. 60/593,114 (“3114”), “System and Method of Blocking Pornographic Websites and Content”, filed Dec. 12, 2004; No. 60/593,115 (“3115”), “System and Method for Attacking Malware in Electronic Messages”, filed Dec. 12, 2004; No. 60/593186 (“3186”), “System and Method for Making a Validated Search Engine”, filed Dec. 18, 2004.

We will refer to the above collectively as the “Antiphishing Provisionals”.

Our method can be divided into two parts. The first concerns mostly an NSP, and the second deals mostly with an ISP.

NSP Method

A modern NSP often has a router that has highly advanced filtering capabilities. It might be programmable in some language like C or C++. The router sits between the customers and the Internet. Without loss of generality, we shall assume there is only one such router, though there might be several, possibly physically co-located. Typically, the router can do mirroring and redirecting. Mirroring is where packets are copied to another network or subnet or to another NSP machine. Whereas redirecting means sending the packets to another destination. Often, the router can also apply filtering rules on the packets. In general, the rules can be functions of any data in the packets. Including the header. Specifically, and importantly, the rules can use the source and destination fields and the port number at the destination address.

Let Amy be a spammer, with a domain bogus.com at the NSP.

Consider the outgoing packets. The NSP can mirror the data stream and sample some subset of it according to various rules. At the simplest level, suppose it decides to sample some percentage of the traffic. It might choose to look at only those packets going to the standard port for email, 25. These packets then get copied to its computer, S.

On S, the packets can be studied using various antispam (and other) methods. Optionally but preferably, these include those invented by us in the Antispam and Antiphishing Provisionals. Specifically, the swarm clustering method in “1745” can be used to find clusters (swarms) of domains, extracted from the links in the message bodies.

As an aside, it should be noted that a packet that constitutes part of an email message's body is not the entire message. The rest of the message body and the message header are in other packets. But our methods can be applied, with trivial modifications, to body packets, where effectively we can treat the body of such a packet as an entire message body. Plus, under the Internet Protocol, every packet header has a source field. It corresponds to an NSP customer's assigned address, or one such address in a set of assigned addresses. While much data in a packet header can be falsified by Amy, the source field cannot, if she wants her messages to reach their destinations. Because under the handling of email, the receiving mail server needs to send data back to the sender machine. Without a valid sender datum, the mail server will not be able to reconstruct the message.

We say that the source field in the packets is canonical. The destination field is also canonical. This can be used as a factor in the router deciding what packets to mirror. Suppose, for example, that some large ISP is complaining about receiving spam from the NSP. The NSP can find the ISP's addresses, and then selectively sample packets heading to these. This helps it drill down to find suspect messages.

A refinement is that S might attempt to reconstruct entire messages from its packets, before applying our antispam methods. In general, an entire message cannot always be found, because it might have been broken into packets, some of which were not mirrored to S.

From the domain clusters, a sysadmin at S can classify these, as per our methods of the Antispam Provisionals, in order to find spammer domains. Or, the sysadmin might already have access to a blacklist or list of clusters of spammer domains. A blacklist is a one dimensional list of domains, with no internal structure. A cluster list has a higher dimensionality and contains far more information about relationships between its constituent domains. For brevity below, when we refer to a blacklist, this can also include a cluster list. Note that given the latter, a blacklist can be trivially obtained, merely by writing out all the domains in the clusters into a single list.

These lists can be found by external means. Possibly from some organization using our methods to make a large, comprehensive and timely blacklist, that it licenses to the NSP for a usage such as that of this invention. Or, the NSP might have compiled the blacklist from its incoming messages, possibly using our methods of the Antispam Provisionals.

Suppose now that S has found packets with links to spammer domains. The NSP can track this down to which of its customers sent the packets. Its router can increase the sampling of packets coming from those customers, for a more comprehensive analysis. This can also enable a greater success rate in reconstructing entire messages from the packets.

One benefit is that we can search for various heuristics, which we term “styles” [“1174”] that are related to information in the message headers, and in the process of making a Bulk Message Envelope (BME) [“8757”] from messages. For example, we can see if the messages from bogus.com have a From field that is not someone@bogus.com. It is very characteristic of spam that this field is forged. This gives us a simple test that can increase the confidence that we are correctly assessing Amy as a spammer. Here, the NSP has a big advantage in studying its customer's outgoing messages, over analyzing incoming messages. The latter come from mail relays, letting the spammer obscure her injection point for the messages. But an NSP's customers cannot usefully forge their source fields, as explained above.

Likewise, if we find that a BME made from several messages has the style that it has different subject lines, then this is also very typical of spam. Or if an assembled message has relays in its header that are forged. Because a message can only correctly have relays that are in the customer's domain, if that. Here, by assumption, the outgoing mail has not explicitly gone into a mail relay run by the NSP. Typically, if a customer was a spammer, she would not want this, because it lets the NSP run many antispam tests on her messages.

While a customer's outgoing packets are being put under more scrutiny, the NSP could tell the router to redirect the original packets into a queue. Where this queue might be emptied at a slower rate, or perhaps even not at all, while the NSP is still conducting its assessment. If the queue were to fill up, then perhaps the latest packets might be discarded. The size of the queue might be chosen as some function of how many outgoing packets or messages the customer might reasonably be expected to issue, if she were not a spammer. This size might be specified in the customer's contract, or be a function of that contract. Imagine for example a commercial customer that persuaded the NSP that it had a valid need to regularly send solicited mass mailings. But under these circumstances, why should the NSP even be evaluating the customer's packets? Because the customer could have told the NSP false information about its business practices. Or, it might have been taken over and is now a bot. Our method lets the NSP dynamically check its traffic, without having to depend on static customer data.

The packets at S can also be studied for the presence in the packet body of links to addresses or domains at the NSP's customers. Especially if these are http or https hyperlinks. Plus, if the links use a non-default port, this fact might be considered “unusual”, and possibly trigger the setting of a style. The NSP can programmatically have heuristics like these that are searched for.

The NSP might have a whitelist of banks and other financial institutions. Or, in general, of large corporations, where these might be targeted by phishers. Typically, a phishing message would have links to the bank it is trying to imitate, say. But there would then be a link to a computer that the phisher controls. So a packet at S might have its links extracted, if any, and compared against this whitelist, where this might be a comparison of base domains [“8757”] or of entire domains. If a packet has domains in the whitelist, and also one or more domains or addresses that are the customer's, then a style might be set here (“Possible Phish”, say).

Of course, the NSP might apply the deterministic antiphishing methods of the Antiphishing Provisionals. This could be done after the above style was detected, for instance.

Also, by sampling a customer's outgoing messages, if these are plaintext, then the NSP might apply methods to make an “Interest Set” for the customer. This is a list of topics or keywords that are commonly found in its messages. Optionally, the NSP might periodically ask the customer to define explicitly its interests. It might be expected that Amy would give misleading information here, when she signs up as a customer. But this method lets the NSP programmatically check a customer-defined Interest Set against an observed Interest Set, for discrepancies.

The NSP may possibly also be able to use this to detect malware that has been installed on a customer's website, unbeknownst to it, that is sending out spam. Because consider the difference between a non-spammer and a spammer customer. The non-spammer is likely to be using its website and messaging in an innocuous fashion, with a certain Interest Set that remains constant or changes slowly over time. If it gets taken over by malware, the chances are that the website has a prior respectable track record with the NSP. Hence the NSP might try contacting the customer to inform of possible malware on her machine.

A spammer customer is less likely to indulge in some period of innocuous usage after she starts her website, before sending out spam. That is more work for her. Plus, it costs her money, to be the NSP's customer. If she delays using the website for her real purpose, then it increases the financial cost. Hence, if the NSP detects a discrepancy between Amy's submitted interests and what it sees soon after she starts her website, then there is greater chance of her being a spammer.

If the NSP has a cluster list, and it finds that a minimum number of incoming or outgoing packets have links to domains in different clusters, then it may choose to merge those clusters. Here, it might have heuristics to determine what that minimum number might be. This might vary with circumstances. Also, if it merges clusters, then it might convey such actions to an external organization that it got the cluster list from, if the cluster list originated externally.

For each customer, the NSP can make a profile of the typical number of outgoing and incoming messages it receives in a given time period. Plus also other information about the distribution of such message types. This profile might be considered an “Activity Set”, by analogy with the Interest Set defined above. So if Amy sends out mostly email, and gets back mostly http, then her actions might be placed under more scrutiny.

Our method of testing outgoing messages that are email also applies to messages in other protocols. Where it might be anticipated that spammers might also avail themselves of the means to send many copies of such messages. It should be noted that above, where we have focused on email, most of the statements can be easily generalized to other messaging protocols.

Specifically, our method also applies to peer-to-peer (p2p) protocols, where Amy might be running a p2p server, that possibly is permitting large scale copyright infringement. A p2p server is likely to have far more outgoing messages than incoming.

The NSP should have, as part of its Terms of Service agreement with its customers that it has the right to delay the sending of outgoing messages, in order to conduct the above analysis. And also the right to drop some or most of these messages, if they are construed by it as spam.

The NSP might also have a policy of restricting a customer to the usage of certain protocols and ports. Some customers may only need a limited range of these. It lets the NSP charge more for unrestricted protocol and port usage. But for customers that are restricted, it also gives the NSP more data to apply against the sampled packets outgoing from the customer. Malware might have backdoors or usages where there is the invoking of a non-default port for a certain protocol, say. Or the use of a protocol not on the customer's approved list. This gives the NSP a means of detecting malware infiltration.

It should also be noted that customers willing to use such restrictions might be running simple websites, and perhaps not be technically savvy. These are the ones that might be more likely to have malware on their machines, as compared to a large commercial website, with experienced sysadmins.

Spammer Strategies

There are typically three things a spammer at the NSP can do, with respect to her website at the NSP

Send spam from locations outside the NSP, with links to her website.

Send spam from her website, with links back to it.

Send spam from her website, with links to websites outside the NSP.

Of course, it is possible that spam may not have links. But spammers prefer to send spam with links because this makes it easier for a recipient to click on the link and then make a purchase at the spammer's website. Other types of spam entail more manual effort by the recipient, and hence increases the chance that she will not buy anything. So we focus on spam that has links.

The items in the above list are not mutually exclusive. They represent extremes of possible behavior by Amy, and she might choose to implement some combination of these. But they are useful for the NSP to perform countermeasures against.

Consider the first item. This is the hardest to detect if the NSP uses just data it extracts from its incoming and outgoing mail. Here, Amy's domain gets http and https requests. But so too might other NSP customers. Often, many customers with domains run web servers. We can imagine a customer that does not send out unsolicited mass mailings, but perhaps advertises in various search engines. Then it hopes to get many http requests, when users of the engines click on its ads. So for the router to detect incoming http and https requests in its sampling is, in and of itself, insufficient evidence of spam. Also, these requests are short in size. Unlike sampling an outgoing packet of an email message, there is very little content in an incoming http packet. So packet body analysis is unlikely to be fruitful. Nor should the NSP use rankings of its customers based on the number of such requests they get. As explained, a customer highly ranked might not be a spammer.

If Amy were to send spam, from outside the NSP, to its other customers, then the NSP might, by sampling these incoming packets and using various antispam methods, be able to identify her domain from the links and classify it as a spammer domain. But if she is careful not to do so, then the NSP has little chance in identifying her. Except by subscribing to external blacklists or cluster lists. In other words, the NSP has to, by necessity, rely on external organizations to identify her domain as a spammer.

Consider the second item. She sends spam from her website, with links to it. There may also be links to other domains, where there might also be in the NSP's purview, or external to it. In this case, Amy is probably a relatively respectable spammer. She may be selling a product that is legal and inoffensive. (E.g., playing cards, laser printer toner cartridges.) But the key difference between this case and the previous is that she sends out spam from her domain. Given the low clickthrough rates of spam (often less than 1%), she has to send out many thousands or millions of messages. From a signal analysis viewpoint, it is impossible to hide this from the router's sampling. Plus, if it is email, she has to send mostly to the default email port, because most mail servers listen on that port. She has little leeway to change this port in her packets. The more packets she sends out, in some time period, the more likely the router to detect it. And the router can use adaptive logic to increase the sampling.

Then, as discussed earlier, the router can see from packet analysis if fields in the message headers are forged. If so, then it is a high probability of spam. But if Amy does not forge her message headers, like the From field, then this leaves her vulnerable to simple, first generation antispam methods at the destinations. Where, for example, those ISPs might make a blacklist and put the domain in her From field into it. Then, future messages with that domain will be blocked.

This invention extends the scope of the Antispam and Antiphishing Provisionals and answers a difficult problem faced by the NSP.

Consider the third item. The opposite of the first item. Here, Amy is using this NSP as an injection point for her spam, which points to an external domain of hers. Then, if or when the NSP discovers that she is sending spam via it, it will shut down her account. She will then move to another NSP. Though in practice, she might have accounts at several NSPs concurrently. The method for dealing with this is broadly the same as for the previous item. Namely that the volume of messages cannot be concealed, and that their contents can be scrutinized.

One point to note is that if the NSP regularly obtains an up to date and comprehensive blacklist or cluster list, then it can check domains found from packets against these.

Another method can be used for the second and third items if Amy's domain name has some correlation with what she is selling. For example, if she is selling toner cartridges, it might be “cheaptoners.com”. Or if it is a gambling domain, it might be called “placemorebets.com”. As is well known, domains can have meaning, unlike IP addresses. This is also true, and perhaps especially so, for pornographic domains. So Amy's domain might be semi-permanent, inasmuch as she will try to use it as a link destination for as long as she can find an NSP to offer an address for it, and for as long as it gets enough hits to make money for her. The latter may be a function of how soon it gets on various blacklists, and how extensively used those lists are.

Now imagine that her domain is at another NSP. Over the length of time that she operates it, she will probably send out many millions of messages. Often in batches or pulses, from some of her accounts at some NSPs. Suppose there is an organization that has amassed an up to date and comprehensive blacklist or cluster list. It might find her domain, based on the first set of spam she sends out. Then, this NSP can use that list, to detect a second batch, that now comes from within its network. Thus, the NSP might not have a “zero-day” capability against her first batch of spam, if that comes from its network. But it can detect later batches, incoming or outgoing. This is still advantageous to the NSP. Because it undermines the profitability of her website, by making it harder for her to send spam pointing to it. Over time, if the NSP does this, and other NSPs do not, then it makes the NSP less attractive to any spammer.

When the NSP finds that Amy is a spammer, it can immediately terminate her account. Or, it might choose to discard some or all of her outgoing emails. Plus possibly scrutinize her incoming packets, to find where she might be logging in from. The latter might be especially useful if Amy was sending out phishing messages. Or, similarly, if her website was a pharm. Likewise, it could scrutinize her outgoing packets that are not email. Especially if any of these are rlogin, telnet, ftp, ssh or similar such, that have interactive remoting capability.

ISP Method

In our Antispam and Antiphishing Provisionals, we described various methods to attack spam and phishing. Here, we combine various elements of those methods and new elements into another method of combating both types of malware. In what follows, we describe our method as being used at an Internet Service Provider (ISP), against incoming mail. In general, with trivial modifications, our method can also be used on the ISP's outgoing mail. Also, our method is not restricted to an ISP. Any company or organization that runs a message (e.g. email) server on a computer network (e.g. the Internet), can use our method.

In “8757”, we explained the key idea of a Bulk Message Envelope (BME). We apply canonical steps to reduce the visible variation in an electronic message, and then make several hashes of the resultant text. Each BME is characterized by a unique set of hashes. The message could be (and thus far usually is) email. But in general, it could be any type of digital electronic communication, like Instant Messaging or SMS.

A spammer (“Jane”) usually sends many copies of a message. She might introduce variations in each message, to try to make it unique across all the copies. A major objective of making a BME is to find Jane's base message and how many copies of this have been received by the ISP.

Our method can be used in the message processing stream. Typically, it might get messages from the ISP's machine that gets the incoming mail. The method operates on the messages, and then passes them, possibly suitably modified, to the ISP's mail server, which can then make decisions as to the disposition of those messages. These decisions can be based, wholly or in part, on any changes we made to the messages, or perhaps on the fact that we did not change some messages.

The ISP might programmatically instruct our method to deal with certain messages in certain ways. For example, if our method deems a message to be spam, it might be told to discard the message, without forwarding it to the mail server.

The method might be instantiated in a standalone appliance (making it a “system”), or it might be implemented in software running on an existing machine of the ISP.

The method can run on an archive of messages that was copied from the incoming or outgoing messages.

The method classifies each message it gets as one, and only one, of three types

Spam.

“Good” bulk mail that is not spam. Like newsletters.

Single. This is most people's actual email that they send to each other.

If the method classifies a message as spam or good bulk, then it writes extended tags into the message's header. Each tag is a line that starts with “X-Metaswarm: ”, and contains information about the message that the method has found. This technique of writing such lines into the header is an accepted practice used by other antispam companies and methods (like the open source SpamAssassin). Other programs that get these messages, and know about these tags, can make their own decisions about what to do with the messages, based on the particular tags for each message. For example, a program on the mail server might then divide a user's incoming mail into three folders, Inbox, Bulk and Spam, based on those tags.

This usage of custom header tags is specific to email messages. For other types of messages, our method might write its assessments in similar tags, if those messages have provision for this. Or, our method might use other means to attach its assessments as metadata that accompanies the messages as they undergo further downstream processing.

The method uses a static blacklist. This is a list of domains deemed to be spammers (aka bulk mailers) or phishers. The ISP could compile it using various means or get it from various sources. Note that it does not have to exclusively use one means or source. It could combine data from various means or sources into the list. Optionally, it could use our methods of [“8757”, “1745”] on earlier sets of messages it received. Specifically, it might use the clusters in “1745” to help it efficiently classify domains that are found to have relationships with each other. Optionally, it could download a blacklist from an Aggregation Center (“Agg”) using the antiphishing methods of [“2245”, “2458”, “2528”, “2640”, “2644”]. Where the Agg might be using [“8757”, “1745”] and [“2245”, “2458”, “2528”, “2640”, “2644”] to make its blacklist.

The static blacklist may in fact periodically change. An updated blacklist might be regularly downloaded from the Agg, for example. But we say the blacklist is “static” because the method optionally but preferably uses another blacklist, which we call a “dynamic blacklist”. This can change on a far more frequent timescale than the static blacklist, and it changes in a totally different manner.

The method also uses a static archive of BMEs (“static BMEs”). This might be obtained by various means or from various sources, much as was done with the static blacklist. One way is to run our methods of the Antispam Provisionals on an earlier set of messages gotten by the ISP. Then, from those BMEs, we might pick the BMEs with the highest message count, and which are considered to be spam, or perhaps just bulk (like newsletters). So the static BMEs are customized for that ISP, based on the most common messages it has recently received.

An Agg might also furnish static BMEs. This might be based on its customers (ISPs or organizations) that choose to upload a subset of their BMEs to it. The Agg might combine these on a global basis. But the Agg could also have manual or programmatic methods to search for any regional correlations. Hence, the static BMEs offered by the Agg to an ISP might have some combination of global or regional BMEs. In both cases, the merit to the Agg offering static BMEs is that the ISP can get, on a broader scope than just based on its data, the most common BMEs that it might encounter.

But it also has two optional dynamic archives of BMEs. One, “dynamic blacklisted BMEs”, is found from BMEs of messages with domains hit by the blacklists. The other, “dynamic BMEs”, is found from messages that are not in the static BMEs and which are not hit by the blacklists.

Below, we describe the steps in a basic instantiation of our method. Each step is optional. Though of course, if all the steps are omitted, the method is trivially empty. A preferred implementation is to apply all the steps.

When the method starts, it reads from files, or obtains from databases, the static and dynamic blacklists, and the three BME sets. The dynamic blacklist and the dynamic blacklist BMEs and the dynamic BMEs are altered below, and are periodically saved to disk or a database. So that if the method has to be stopped and restarted, then the knowledge in those sets can be used across different runs of the method.

We also read an Ok file. This is a list of domains that are considered by the ISP or Agg to be good. By explicit construction, the static blacklist does not have any entries in the Ok file.

When the method gets a message, it does the following steps, where each step is called a filter

From the sender address (e.g. “joe@a.somewhere.com”), it finds the sender base domain, “somewhere.com”. If this is in the static blacklist, then the message is considered spam, and this header tag will be written—“X-Metaswarm: Sender domain in static blacklist”.

If the sender base domain is in the dynamic blacklist, then the message is considered spam, and this header tag will be written—“X-Metaswarm: Sender domain in dynamic blacklist”.

In the header, it finds the mail relays. If any of these are in the static blacklist, then the message is considered spam, and this header tag will be written—“X-Metaswarm: Relay in static blacklist”, along with one of those relays.

Or if it is in the dynamic blacklist, then the message is considered spam, and this header tag will be written—“X-Metaswarm: Relay in dynamic blacklist”.

Then, the domains in hyperlinks in the body are found. Assuming that there are any, of course. Though most spam has these links. The base domains are compared against the static blacklist. If any are in it, then the message is considered spam, and this header tag will be written—“X-Metaswarm: Body link domain in static blacklist”, with that domain. And the BME of the message is added to the dynamic blacklisted BMEs. Optionally, we extract any domains in the message and add them to the dynamic blacklist, if the domains are not in an Ok file, and if the domains are not already in the static blacklist.

The base domains are also compared against the dynamic blacklist. If any are in it, then the message is considered spam, and this header tag will be written—“X-Metaswam: Body link domain in dynamic blacklist”, with that domain. And the BME of the message is added to the dynamic blacklisted BMEs. Optionally, we extract any domains in the message and add them to the dynamic blacklist, if the domains are not in an Ok file, and if the domains are not already in the static blacklist.

When doing the canonical reduction of a message, we look for various Styles. Each Style suggests spam. If the message has more than a certain minimum of these Styles, then we consider it to be spam. The header will have tags for each Style present in the message. Optionally, we extract any domains in the message and add them to the dynamic blacklist, if the domains are not in an Ok file, and if the domains are not already in the static blacklist. The choice of the minimum number of Styles can be done by various means outside this method. We have found a choice of 3 to be useful.

The message has now been reduced to a BME. If this BME is in the static BME set, then we consider it to be spam, and this header tag will be written—“X-Metaswarm: Canonical message in static BME archive”.

Otherwise, if the BME is in the dynamic blacklisted BMEs, then we consider it to be spam, and this header tag will be written—“X-Metaswarm: Canonical message in dynamic blacklisted BMEs”.

If the BME is not in the dynamic BMEs, then we've never seen the message before. If the message has not been “hit” by the earlier filters, then it is written to the singles file. Its BME is added to the dynamic BMEs, so that we can detect any later instances of it.

But if the BME is already in the dynamic BMEs, then we merge it into the appropriate existing BME in that set. This means that the message has been seen at least twice by the program. In the merging, if the combined BME has different senders, then we consider this to be spam. This is very typical of spammers; they forge their sender addresses. So finding a BME with 2 or more different senders is a very strong indicator. Likewise if the BME has 2 or more different subjects. A spammer might generate many copies of a message, with different subjects, to avoid a simple antispam filter that checks only for some subject words. Also, if the combining of the BME shows that the different messages in the BME have different sets of domains, then this is what we call “templating”. In any of these cases, we consider the message to be spam, and appropriate header tags will be written. Optionally, we extract any domains in the message and add them to the dynamic blacklist, if the domains are not in an Ok file, and if the domains are not already in the static blacklist. If the BME does not have any of these Styles, then we consider the message to be “good” bulk. It is bulk because it has been seen at least twice, but it does not have the key properties of spam.

In the above filters 1-6, if a message is marked as spam, then its BME can be added to the dynamic blacklisted BMEs. Optional but preferred. The idea is that these steps all involve testing against the blacklists. If an email fails this test, then we can amplify this by saying that its BME is “bad” (i.e. put into the dynamic blacklisted BMEs). So that any future message, which might have different domains, that are not in our blacklists, but which uses the same BME template, will be caught in filter 9.

Reduction to Practice

We have reduced our method to practice. We ran it on various sets of incoming and outgoing messages at an Asian ISP. This also had the merit of testing the (human) language independence of our Antispam and Antiphishing Provisionals and of the current method. The messages were predominantly in Chinese, but a significant fraction were in English. Chinese is perhaps the hardest test of language independence. It uses a large symbol set of pictograms.

Our method and the relevant methods of the Antispam and Antiphishing Provisionals were successful in handling Chinese messages, without any changes to the methods.

In one message set, 84.3% were diagnosed as bulk—either spam or good bulk. The spam was 80.3% and the good bulk was 4%. This classification of 84% of the messages as spam or good bulk compares very favorably with Brightmail Corporation, which only promises to classify up to a maximum of 50% of email. Purely for illustrative purposes, the filters detected the following:

| Filter | Messages | % |
|---|---|---|
| Sender domain in static blacklist | 17961 | 19.3 |
| Sender domain in dynamic blacklist | 42 | 0.05 |
| Relay in static blacklist | 4117 | 4.4 |
| Relay in dynamic blacklist | 29 | 0.03 |
| Body domain in static blacklist | 58031 | 62.4 |
| Body domain in dynamic blacklist | 668 | 0.7 |
| Too many bad Styles | 23692 | 25.5 |
| Canonical message in static BME archive | 36374 | 39.1 |
| Canonical message in dynamic BMEs | 384 | 0.4 |
| Canonical message has different Senders | 958 | 1.0 |
| Canonical message has different subjects | 418 | 0.4 |
| Canonical message has different domains | 0 | 0 |

Each message was analyzed by all the filters, as mentioned above. This over-classification

shows that we could require that a message be hit by more than one filter, in order to be classified. The redundancy acts as a safeguard against mis-classifying a message. Of course, it also means that in the above table, the sum of the percentages is greater than 100%. The over-classification is also given here

| Number of filters | Number of Messages |
|---|---|
| 1 | 29904 |
| 2 | 25260 |
| 3 | 15933 |
| 4 | 3189 |
| 5 | 339 |

This is the breakdown of the 78331 messages that were classified as spam. The first line means that 29904 messages were detected by only 1 filter. Whereas 25260 messages were detected by only 2 filters, etc. Thus the filters are highly robust.

The above total of 84% of the message set as spam also jibes with a study performed recently by Postini Corporation. Their main antispam method uses Bayesians. They sampled a set of email. Their Bayesian only hit some 50% of the mail. Then, they studied how much spam was actually in the sample. From the messages that were not hit, they retrained their Bayesian, to increase the hits. And this was repeated until they estimated that their set had about 80% spam. Note that their method could not actually work in real time against an incoming message stream. Their procedures deliberately violated causality. Clearly, different sets of email would give different results. But they suggested that currently (2005), 80% or more of email is spam. This agrees with our findings. Plus, our findings are based on achievable, real time results.

Extensions

Our method does not need to know the ISP's valid usernames. Some spammers use a dictionary attack where they guess likely usernames. If we had access to the directory of usernames, we could improve our results. If an incoming message was addressed to several users, and one or more of these were names that did not and had never existed, then this can be used as an extra Style to help classify the message. Plus, if there were several recipients, and two or more of these did not exist, then this is more suspicious than if only one did not exist. Because this reduces the chance that the sender accidentally mistyped just one username. This Style can be used in conjunction with any other Styles found from the message and with other properties, like whether the message's domains were in the blacklists.

The above implementation had a message proceed through the filters, even after it was hit by one filter. Another implementation is for the method to have an input parameter, “minFilters”. When this is greater than 0, it means the number of filters that hit a message, after which, the message can skip the rest of the filters. Faster throughput.

When we found the number of Styles of a message, it was a simple count. Though above, we implicitly drew a distinction between the Styles that are intrinsically single message (like “invisible text”), and those that arise only after we have a BME made of more than one message. In either group, or across all Styles, we might have some numerical weighting that treats some as more indicative of spam than others. So that if this weighting is greater than some amount, then the Style filter has hit the message.

Likewise, across the filters, we might weight them differently.

When a message is hit by a particular filter, it may be desirable to apply a Bayesian to the message. In part to aid in the classification of the message, and hence, of any domains it might point to.

The order in which filters are applied can be varied. For example, imagine an implementation where the above steps are done until a filter hits the message. Then the subsequent filters are omitted for that message. The method might have logic to dynamically vary the order of filters. So that filters which often hit messages might be applied first, for faster processing. Also, the order might also be input from external sources like an Aggregation Center and this might be done several times during a given run.

Managing BME Sets

As time proceeds, the dynamic blacklist and the two dynamic BME sets can grow. At some point, this might reach the limits of the memory available to the method. The blacklist, as currently implemented, is small (a few megabytes) relative to the typical computer memory size (hundreds of megabytes or several gigabytes). But the BME sets are often larger than the blacklist. So there are two possibilities to constrain the BMEs. A BME might have a timestamp of when it was last seen in the data. Then, periodically, BMEs before a certain time might be discarded. Or, BMEs with the number of messages being less than some amount might be discarded. Some combination of both of these measures might be taken.

We suggest that the simplest, preferred implementation is that BMEs with only one message each be discarded. But we desire BMEs with high message counts. And each such BME must start with a message count of 1. So it might seem that if we throw away BMEs with count=1, then we might abort the construction of a future large count BME. In practice, this is unlikely. A spammer must send a lot of messages, to be economically viable. If she is going to send n messages to us, and we have just gotten the first one, and we did the above, then we are still likely to amass a BME for the later n−1 messages. She cannot impose much of a delay between her messages. Because she has so many messages, that amounts to a reduction in her income per day or other time interval. And even if she did so, then per unit time, we will get fewer messages from her, which is still a reduction in the amount of spam gotten by the ISP. Plus, this is actually the most desirable antispam method, from the ISP's viewpoint. Because here, the spam that is never sent per unit time means that it does not consume the incoming bandwidth or the clock cycles of the ISP's machine that faces outside.

A variant on discarding some BMEs is to do this to some of the static BMEs. While the latter set is typically read from file at startup, and the file is not changed, our method might decide to discard elements of this from its memory if their counts are too low, or they haven't been seen in the message stream.

Independently of these BME retention steps, it is possible that this method might discard some fields or reduce the number of entries in such fields, in a full BME. These are used in other methods, for a full analysis. But in this method, some fields might have little or no relevance. For example, a full BME would have the usernames of the recipients of its messages (assuming we are looking at incoming mail). But in an implementation of this method, it might be decided that retaining such usernames is not needed.

Blacklisting Subdomains

The above implementation uses blacklists with no internal structure. Each is just a simple set of domains.

We have an Ok list of good domains. Which are used to prevent these domains from being in either blacklist. These are written as base domains. It is also possible to have a finer grained control over any of these entries. Imagine that the Ok has theta.com. It is a major ISP, so our ISP does not want to block messages from users at it, and these might have links back to theta.com. But imagine that theta also hosts websites for third parties, as sub-domains. So there might be alpha.theta.com, beta.theta.com etc. Each might maintain its own web server.

Suppose alpha is a spammer. She might send spam directly from their websites. So these would typically pass through theta's gateway to the Internet. Or she might inject spam into the Internet, but from outside theta's network. In either case, the spam might (probably will) have links to alpha.theta.com.

Our ISP would like to block any messages referring to alpha.theta.com, but not those that just refer to theta.com. It might appear that one can just add alpha.theta.com to one of the blacklists. But a blacklist should only store base domains. Otherwise, a spammer who owns spam.com, say, might make numerous subdomains, and hope that only those get blacklisted, and not her base domain. It makes the blacklist larger and the comparison of a domain with the blacklist longer.

A better approach is to use the Ok list, which can be expected to the smaller than the static blacklist, and to extend it in this manner. An entry in the Ok, like theta.com, can have optional associated data. Like {alpha, beta}. (Since the latter set is associated with theta.com, this common base domain can be factored out, to save storage.) So that when our method extracts links from domains in a message body, or looks at the sender or relay domains, then it can search to see if any “full” domains match these. If so, it could blacklist the message. Also, the list can be simplified. It might just say (*). This means that a message with links to any subdomain of theta.com, or from any sender at such a subdomain, will be marked as spam. But, as before, messages from just strictly theta.com, or with links to just that base domain, will not be marked as spam. This lets us accept email from people who are just email customers of theta.

The above case was where theta sells subdomains to customers. There is also another important case. Theta might not sell subdomains. Instead, it makes those subdomains for its own uses. These might not be related to pure email, but perhaps are more to do with advertising its own services. But by using the above list capability, an ISP could also decide to classify messages pointing to specific subdomains of theta as bulk.

Enhanced Blacklist

A blacklist might also have style information associated with a domain. Our methods of [“8757”, “1745”, “5037”, “1899”, “1014”, “1174”] easily lets an operator find the average Styles of messages that link to a domain. This could be held as Booleans for each style. Or, each Style might be a fraction in [0,1], indicating its prevalence in the messages.

Now suppose we get an incoming message. Consider the steps where we apply the blacklists against the body's link domains. If such a base domain is in a blacklist, we might also compare the message's Style against the average Style for that domain. If these two are sufficiently different, then the message might not be considered hit by the blacklist. This could be used to let through a message that just has a clickable link to a spammer, but otherwise is “clean” enough, Style-wise. Imagine that the typical spam message for that domain has a group of Styles. Then our method lets someone send that message, without it getting marked as spam.

A domain in a blacklist might also have information about what categories it is in. These categories might span [e.g.] “porn”, “health”, “gambling” etc. The Agg might offer this information as an enhanced blacklist. And the ISP might also choose to determine these for some domains.

Then, the filtering could use the extra information. For example, if a domain is in the blacklist, and the domain is associated with “porn”, then it is hit by the blacklist, as before. But if the domain is associated with “gambling”, then it might only be partially hit by the blacklist. Where here, we are using “hit” as a fraction, rather than as just a 1 or 0.

Spidering

For antiphishing purposes, our method can optionally do various spiderings on links in suspect messages, as described in “2640”. This might be done by our method invoking other processes, possibly running on other hardware, to perform the n-ball search at those links.

The spidering can also be used for antispam purposes. It has been noted that some spammers attempt to evade blacklists by having sacrificial domains that are used in messages' links. If a user clicks on one of these links, she goes to that domain. There, a redirector might send her to another domain and with perhaps another redirector [etc], until finally it gets to a page that is actually sent to the user's browser.

Our method involves the use of a custom spider that can record these intermediate domains. As well as the final domain, of course. Plus, it can set a Style that indicates the use of redirection. Possibly, this Style might be an integer, rather than a Boolean, which counts the number of redirections. The more there are, perhaps the more suspect the final domain, or also too all of the intermediate domains.

A related Style is simply a Boolean that says whether the base domain in the link is the same as the base domain in the page that displays. This can handle the case of several domains aliases to the same IP address.

While some spammers might obfuscate their email, to defeat Bayesian or key word filters, they rarely do so at any destination pages. (Assuming of course that their messages have links to these pages.) Because often a spammer is selling something that requires a buyer to type in her credit card details. So there is incentive for the spammer to present a web page that is as professional as possible. Ironically, this is possibly increased by the rise in phishing. As people become wary of possible pharming websites, it adds pressure to a spammer to maintain a respectable web page.

So a spammer's web page is likely to be more canonical than her messages.

Our method takes advantage of this in the spidering by emphasizing the analysis of the first linked page. We apply our canonical steps of “8757” to the page. This includes finding the Styles of the page. For example, if it has any invisible text. Plus, optionally, we can now apply a Bayesian or key word analysis to that page. Where this is done only against the visible text. The efficacy of this should be higher than on a typical spam email. This analysis can be used to give a programmatic classification of the page. Which can then be used as a classification of the page's base domain. An intent is to perform this as rapidly as possible. In order to catch leading edge spam or phishing. Where both might bring online hitherto unknown domains.

An added advantage of shifting our focus to web pages is that the (base) domains they have are expensive, compared to the cost of a single message. So a spammer can easily send out millions of messages at low cost. But she cannot afford millions of different base domains. Typically, not even thousands. So our method reduces the size of the problem immensely. In part this will be useful if some spammers switch to sending messages with plenty of randomness. So much so that our canonical methods on the messages end up only giving us one message per BME. By switching to the web pages, we can maintain or even enhance the method's efficacy.

What is claimed is:

1. A method of an NSP mirroring or delaying outgoing packets from its customers, to analyse these for the presence of malware, including spam and phishing.

2. A method, using claim 1, where the analysis involves finding “styles” (heuristics) in the packets, that are typical of spam.

3. A method, using claim 2, where the styles include those defined in our U.S. Provisional 60/521174.

4. A method, using claim 1, where the analysis involves finding clusters of domains from links in the packets, using the method defined in our U.S. Provisional 60/481745.

5. A method, using claim 1, where the NSP builds an “Interest Set” of tokens extracted from a customer's packets, over some period of time, and associates that Set with the customer.

6. A method, using claim 5, where the NSP computes a current Interest Set for a recent set of outgoing packets from a customer, and compares that against a long term Interest Set for that customer; using significant discrepancies to suggest that the customer may have been subverted by malware that issues spam.

7. A method of an ISP making Bulk Message Envelopes (BMEs) from its incoming messages, possibly using the method defined in our U.S. Provisional Ser. No. 10/708757.

8. A method, using claim 7, of an ISP finding clusters of domains from the BMEs, using the method defined in our U.S. Provisional 60/481745.

9. A method, using claim 8, of making a dynamic blacklist of domains, by starting with a blacklist and including other domains found from clusters that contain domains in the initial blacklist, provided that these other domains are not in an “OK” list of good domains.

10. A method, using claim 7, of an ISP making a dynamic blacklist of BMEs, found from incoming messages with links having domains in a blacklist.

11. A method, using claim 7, of an ISP using a set of static BMEs, from external sources, where these represent messages considered to be spam, and where the ISP checks incoming messages to see if any belong in this set.

12. A method, using claims 10 and 11, of an ISP classifying an incoming message as one of {spam, bulk non-spam (like newsletters), single}, where “single” is considered to be non-bulk non-spam.
